(19) United States
(12) Patent Application Publication
(10) Pub. No.: US 2025/0328859 A1
(43) Pub. Date: Oct. 23, 2025

(54) DETECTING ERRORS IN DELIVERED ORDERS USING IMAGE ANALYSIS

(71) Applicant: Maplebear Inc., San Francisco, CA (US)

(72) Inventors: Sandrine Meunier, Bellevue, WA (US); Alan Hwang, San Francisco, CA (US); Haochen Luo, Houston, TX (US); Tianyi Mu, San Mateo, CA (US)

(21) Appl. No.: 18/642,365

(22) Filed: Apr. 22, 2024

(51) Int. Cl. G06Q 10/087; G06V 10/764; G06V 10/774; G06V 20/50; G06V 20/62

(52) U.S. Cl. CPC G06Q 10/087; G06V 10/764; G06V 10/774; G06V 20/50; G06V 20/63

(57) ABSTRACT

An online system receives from a device associated with a picker, an image of an order delivered at a location associated with the order for a user and accesses a plurality of features about the order to output a likelihood that the delivered order in the received image is erroneous. The online system applies a machine learning model to the received image of the order and the plurality of features of the order. The machine learning model is trained to predict a likelihood that the delivered order is erroneous. The online system determines that the delivered order is erroneous and transmits a warning message to the device associated with the picker about the identified potential delivery error.

### BACKGROUND

In current online concierge services, delivery agents (sometimes called “shoppers” or “pickers”) fulfill orders on behalf of users by picking the ordered items in stores and then delivering them to a designated delivery location. Occasionally delivery errors occur, such as delivering an order to the wrong location, delivering the wrong order to the correct location, including an erroneous item in the order delivered, or delivering an order with a missing item. When such errors occur, users may submit complaints to the online concierge system, which then must review the complaints submitted by the user and determine whether to take an appeasement action, such as refunding all or a part of an order. In addition to the costs associated with appeasements, delivery errors result in a poor experience for customers.

### SUMMARY

In one or more embodiments, an online system dispatches delivery agents to deliver orders to a delivery location, and the delivery agents send images back to the online system to show proof of delivery. For a particular order, the system receives, from a device associated with a delivery agent, an image of the order delivered at a delivery location associated with the order. To detect errors in the delivery (e.g., wrong address, wrong order delivered, etc.), the system passes a plurality of features about the order to a machine learning model that is trained to predict a likelihood of an error of one or more types. The plurality of features about the order may include the image of the delivered order, information that is extracted from the image, and other data about the order (e.g., a list of items in the order). The online system applies the trained model to these features of the order and outputs, for each of the one or one or more types of errors, an indication about whether the image depicts an error of that type. If an error of a particular type is detected, the online system takes a remedial action to correct the error, such as transmitting a warning message to the device associated with the delivery agent about the identified delivery error.

In this way, the system automatically determines and flags delivery errors, before users complain about the errors and potentially in time for the delivery agents to correct them. This reduces or eliminates the human intervention required to address delivery error complaints from users. Conventional delivery systems lack the infrastructure to provide real-time insights on potential delivery errors. The process described herein collectively contributes to a more efficient and consistent error detection process, thereby significantly improving the accuracy of deliveries from an online system.

### BRIEF DESCRIPTION OF THE DRAWINGS

FIG. 1 illustrates an example system environment of an online system, in accordance with one or more embodiments.

FIG. 2 illustrates an example system architecture of an online system, in accordance with one or more embodiments.

FIG. 3 illustrates an example user interface presented to the picker for fulfilling an order, in accordance with one or more embodiments.

FIG. 4 illustrates an example user interface presented to the picker for taking an image of a delivered order, in accordance with one or more embodiments.

FIG. 5 illustrates an example of an image of a delivered order taken by a picker, in accordance with one or more embodiments.

FIG. 6 illustrates an example user interface presented to a picker warning of a delivery error, in accordance with one or more embodiments.

FIG. 7 illustrates an example error prediction module for an online system, in accordance with one or more embodiments.

FIG. 8 illustrates a method for predicting delivery errors from images of delivered orders, in accordance with one or more embodiments.

### DETAILED DESCRIPTION

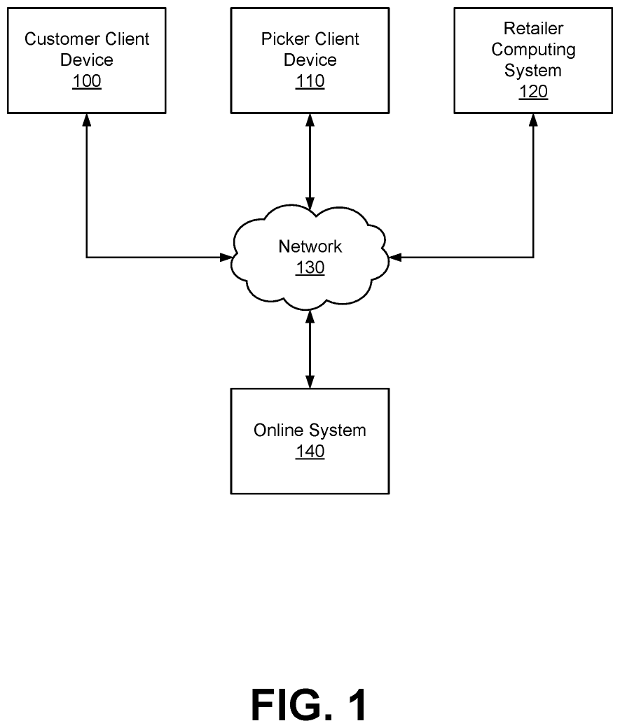

FIG. 1 illustrates an example system environment for an online system 140, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online system 140. As such, there may be more than one user client device 100, picker client device 110, or retailer computing system 120.

The user client device 100 is a client device through which a user may interact with the picker client device 110, the retailer computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a particular retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The user client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a retailer. The online system 140 receives orders from a user client device 100 through the network 130. The online system 140 selects a picker to service the user's order and transmits the order to a picker client device 110 associated with the picker. The picker collects the ordered items from a retailer location and delivers the ordered items to the user. The online system 140 may charge a user for the order and provide portions of the payment from the user to the picker and the retailer.

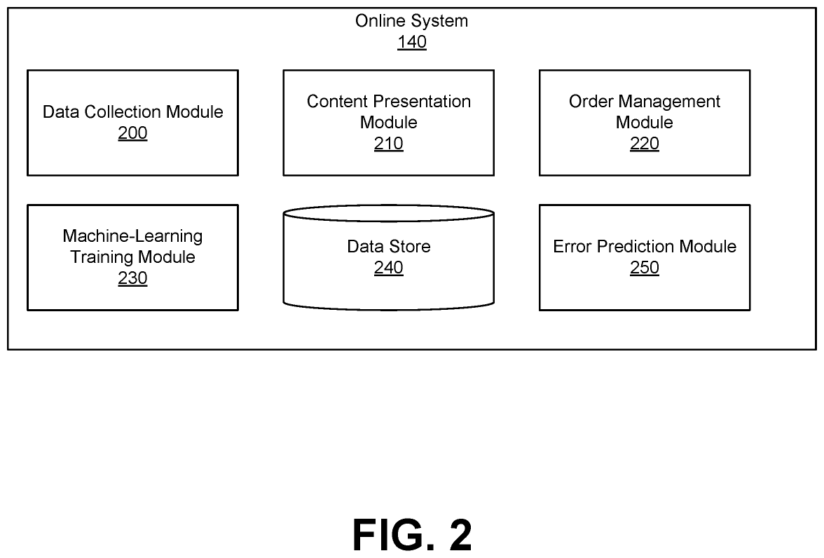

As an example, the online system 140 may allow a user to order groceries from a grocery store retailer. The user's order may specify which groceries they want delivered from the grocery store and the quantities of each of the groceries. The user's client device 100 transmits the user's order to the online system 140 and the online system 140 selects a picker to travel to the grocery store retailer location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

The online system 140 detects erroneous deliveries by applying a machine learning model to an image of an order delivered at a location and to a plurality of contextual features about the order. When an order is being fulfilled by a picker, the picker may be prompted to take an image with a device associated with the picker. The online system 140 receives an image of the order and identifies the order along with a plurality of contextual features. The online system 140 applies an error prediction model to the image and the contextual features, and the model outputs a likelihood that a delivery error occurred, for each of one or more types of errors. The online system 140 may then apply a set of rules to the outputted likelihoods to determine if the order delivered is erroneous, such as by comparing the likelihoods to a threshold. If the online system 140 determines that a delivery error occurred, it sends a warning message to the device associated with the picker.

The contextual features that are input to the error prediction model may include additional characteristics of the location at which the order is fulfilled, items in the order, user history, picker history, pixel data extracted from the image, and characteristics of other orders simultaneously being fulfilled by the picker. User history additionally includes contextual information including, but not limited to, the browsing history of the user during the order session, attributes of the user, and other types of contextual data about the user as collected by the data collection module 200 in the prompt. For example, the browsing history of the user may include an ordered list of websites or pages the customer visited during the ordering session. As another example, the attributes of a user may include profile information such as geographical location, age, gender, and the like of the user. Characteristics of the other orders being simultaneously fulfilled by the picker may be used, for example, to infer if a picker may have delivered an incorrect order from a batch of orders being simultaneously fulfilled by the picker.

In one or more embodiments, the image received by the online system 140 is applied to a data extractor to output metadata about the image. Accessing metadata extracted from the inputted image comprises using text detection (e.g., Optical Character Recognition), object detection, and the geospatial data where the image was taken. In one or more embodiments, text detection may be used to identify object labels and bag labels. Object detection may also include extracting data to identify large objects or distinguishing geospatial features of the image. In one or more embodiments, the contextual features also include accessing an image taken by the user of their delivery location (e.g., an image of the user's front door). By including the additional contextual features as an input to the error prediction module 250 in conjunction with the inputted image, the error prediction module 250 may detect a delivery error.

In one or more embodiments, the error prediction module 250 detects multiple different types of errors. For example, different types of delivery errors may include delivering an order to an incorrect location, delivering an incorrect order to the delivery location (e.g., another order that the picker is fulfilling for another user concurrently with the order being delivered), delivering an order with an incorrect item in the order, or delivering an order with a missing item (e.g., failing to delivery all of the bags associated with an order). In one or more embodiments, when predicting multiple types of delivery errors, the error prediction module 250 comprises a multi-class model that generates a likelihood for each type of delivery error.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a user based on whether the predicted availability of the item exceeds a threshold.

The order management module 220 that manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online system 140. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The machine-learning training module 230 may periodically re-train the machine-learning models described herein, whereby the machine-learning training module 230 updates parameter values of the machine-learning models based on newly acquired training examples. For example, when the model is used to predict likelihoods of whether delivery errors occurred based on received images, the system may later receive confirmation about whether the predicted delivery error actually occurred (e.g., by the picker confirming that they fixed the error). These instances are logged as new training examples, which are later used to re-train the model. In this way, the system continually improves in its function of identifying delivery errors.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The error prediction module 250 applies a machine learning model to detect a potential erroneous delivery by receiving an image of an order delivered at a location associated with the order and a plurality of contextual features about the order. The error prediction module 250 determines with a degree of confidence whether a delivery error type has occurred. The error prediction module 250 transmits a warning message to a device associated with a picker when a delivery error type has been determined.

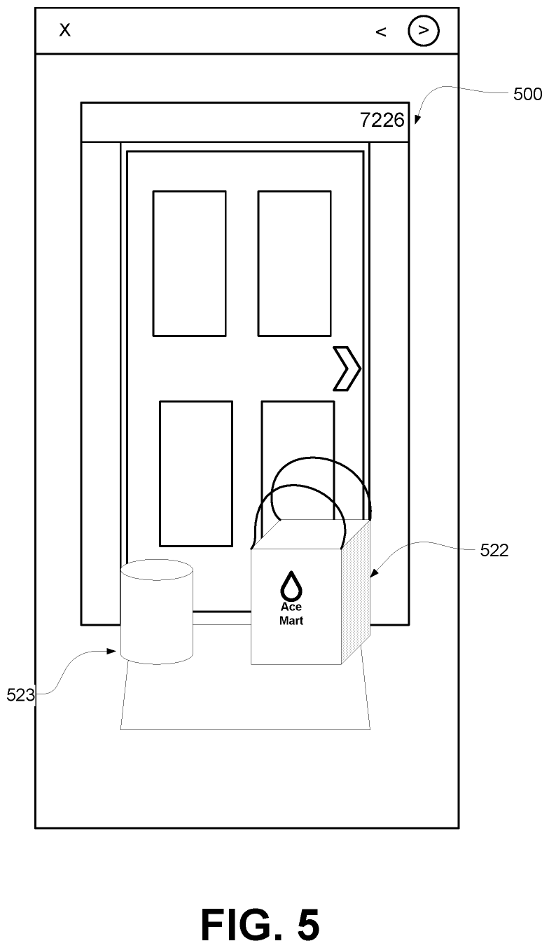

The error prediction module 250 receives from a device associated with a picker of the online system, an image of an order delivered at a location associated with the order. The image of an order provides contextual metadata of the delivery of an order. The module receives contextual information of the order delivery through extracting distinguishing features of the delivery from the image (e.g., a shopping bag label, the number of bags for the order, an address identifier on a house) and distinguishably identifiable items (e.g., oddly shaped item, items not in a bag). FIG. 5 is an example of an image of an order delivered.

The error prediction module 250 additionally accesses a plurality of features about the order associated with the user. The error prediction module 250 receives picker data including geographical data from the client device associated with the picker and other orders in the picker's batch of orders. The geographical data of the image of the delivery offers additional context by confirming that the image from the picker is within a radial vicinity of the user's location. The module receives the location of interest and compares the received locational data of the image to estimate the probability that a delivery error has occurred.

The error prediction module 250 may also receive order data including images of items in the user's order, and a set of flagged identified items. The received images of the items in a user's order are compared with images of the delivery from the picker to confirm that a delivery error has occurred. The received set of flagged identified items (e.g., gallon size bottles, watermelons, or pineapples) helps identify the extracted distinguishable item of the image. The module accesses the items in the user's order to confirm the order has the identified distinguishable item.

The error prediction module 250 may also access the items in the other orders in the picker's batch of orders to confirm that the order has the identified distinguishable item. For instance, if the user's order does not include an identified item of a water bottle jug and the error prediction module 250 receives item data of the other orders in the picker's batch where another order includes the water bottle jug, the error prediction module 250 determines with a higher confidence that the user's delivery is erroneous.

Additionally, the error prediction module 250 receives customer data including a location of the delivery spot, user order history, and images of the user's delivery spot. Previous user order history provides contextual background of a user's preferences when determining whether the delivery is erroneous. The geographical location provided from the user device and the images from the user of the user's location of interest is compared with the received images and geospatial data from the picker.

In one or more embodiments, the machine learning model is a multimodal Large Language Model (LLM), which acts as an image classifier and extracts spatial features of a received image at varying fields-of-view. The error prediction module 250 generates prompts for the LLM to determine the probability of a delivery error, of one or more error types, from the set of inputs described above. In response, and according to the instructions in the prompt, the LLM generates a probability value for each of one or more error types.

In one or more embodiments, the error prediction module 250 determines that the picker has delivered an incorrect number of shopping bags for the order. The module extracts the number of shopping bags of the order in the received image using object detection. The module may also retrieve, from the order information, the number of bags selected from the picker. The module compares the extracted number of shopping bags from the image with the number of bags from the order information to confirm that the number of bags delivered is correct. Additionally, the error prediction module 250 computes, based on the confirmed number of bags delivered, the bag fees to charge to the user.

In one or more embodiments, the error prediction module 250 determines that the picker has delivered the order to an erroneous location. The error prediction module 250 may receive the delivery location specified in the order and compare the received locational data associated with the image to estimate the probability that a delivery error has occurred. Further, the module may also compare extracted features of a received image from the user of the location of interest (e.g., user's front door, user's mailbox, etc.) with that of the received image from the picker.

In one or more embodiments, the error prediction module 250 determines that the picker has delivered an erroneous order to the location. The error prediction module 250 may compare extracted features of a received image from the user of the location of interest (e.g., user's front door, user's mailbox, etc.) with that of the received image from the picker.

In one or more embodiments, the error prediction module 250 determines that the picker has delivered an erroneous order to a location. The error prediction module 250 receives a plurality of contextual features (e.g., orders in the picker's batch, distinguishing items, and the store label of the shopping bags). As an example, the error prediction module 250 may determine that the store label of the shopping bags in the received image do not correspond to the store at which the user placed the order from. Thus, the error prediction module 250 determines with a higher probability that a delivery error type of an erroneous order has occurred.

The error prediction module 250 sends a warning message to the device associated with the picker with the determined delivery error type. The warning message is displayed within a user interface sent to the device associated with the picker. This user interface may prompt the picker to reconfirm that the order the picker selected is correct. If different error types are detected, the user interface presents the different warning messages that correspond to the different delivery error types. In one or more embodiments, the user interface is presented to the picker as soon as possible after the picker sent the image of the delivery, so that the picker is likely to still be at or near the delivery location to correct the error.

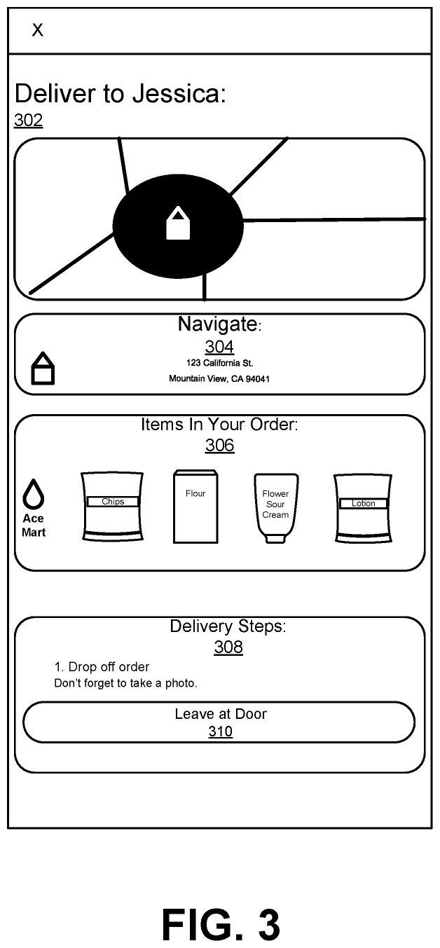

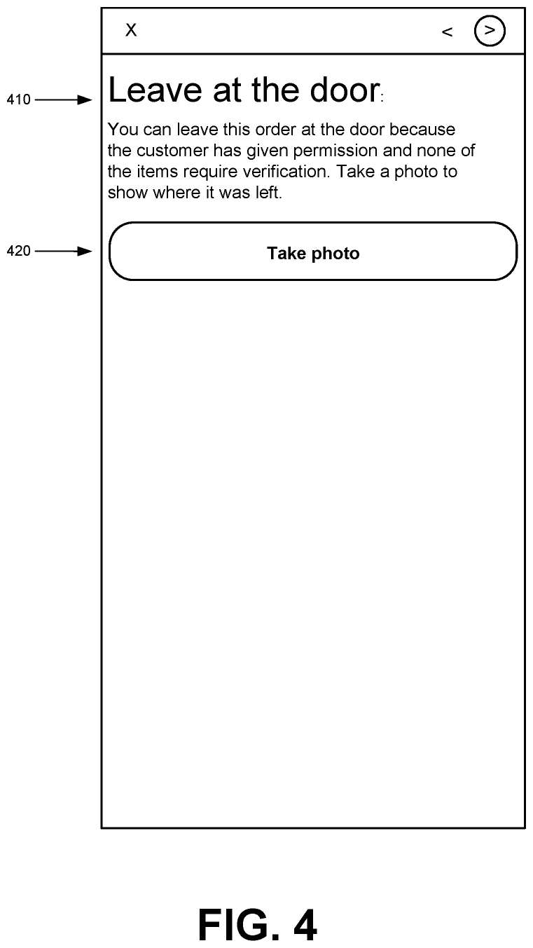

FIG. 3 is an example of a user interface presented to the picker for an order associated with a user for an online system, in accordance with one or more embodiments. The interface provides instructions 302 to deliver to a user, the user's order 306 from a retailer with instructions 304 to navigate to the delivery location. The user interface presents delivery steps 308 to drop off an order and to take a picture of the delivery. When the picker arrives at the delivery location, the picker selects the “Leave at Door” button element 310 which causes the user interface to advance the user interface shown in FIG. 4.

FIG. 4 is an example of the user interface presented to the picker for taking a photo of the delivery. The interface instructs the picker with instructions specific to the order 410 and a “Take a photo” button element 420, which activates a camera in the picker's mobile device and enables the picker to capture an image of the delivery of the order. Responsive to capturing the image, the mobile application sends the image to the online concierge system 140 to predict delivery errors, as described herein.

FIG. 5 is an example of the image taken by the picker, in accordance with one or more embodiments. FIG. 5 highlights extractable features of an image of the delivery, such as location identifiers 500 of a user's door, a shopping bag 522 from a retailer, and one or more identifiable items 523 in the order (e.g., items that are outside of the bag 522 or visible at the top of the bag 522).

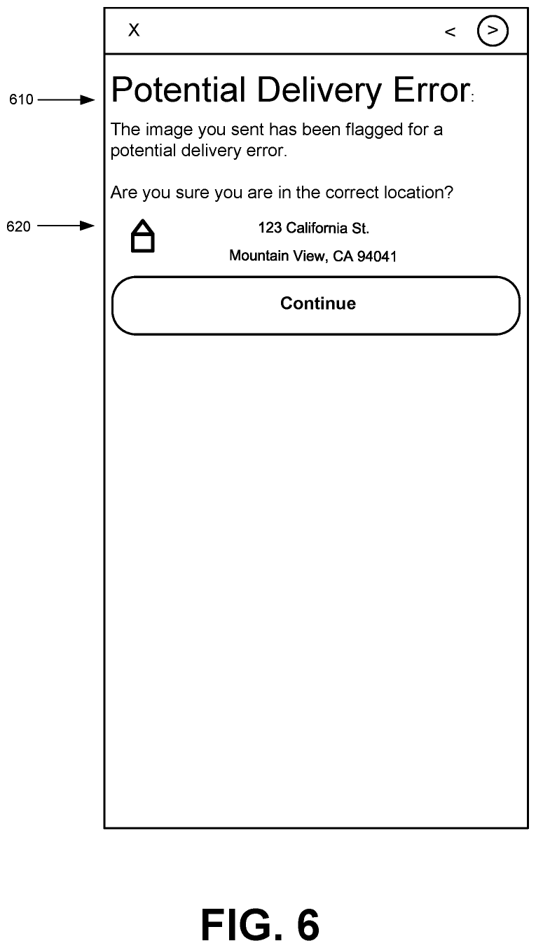

FIG. 6 is an example of an interface presented to the picker upon a flagged potential delivery error, in accordance with one or more embodiments. The image sent from the picker is flagged with a warning message 610. In this example, the user interface prompts the picker to confirm that the location is correct 620.

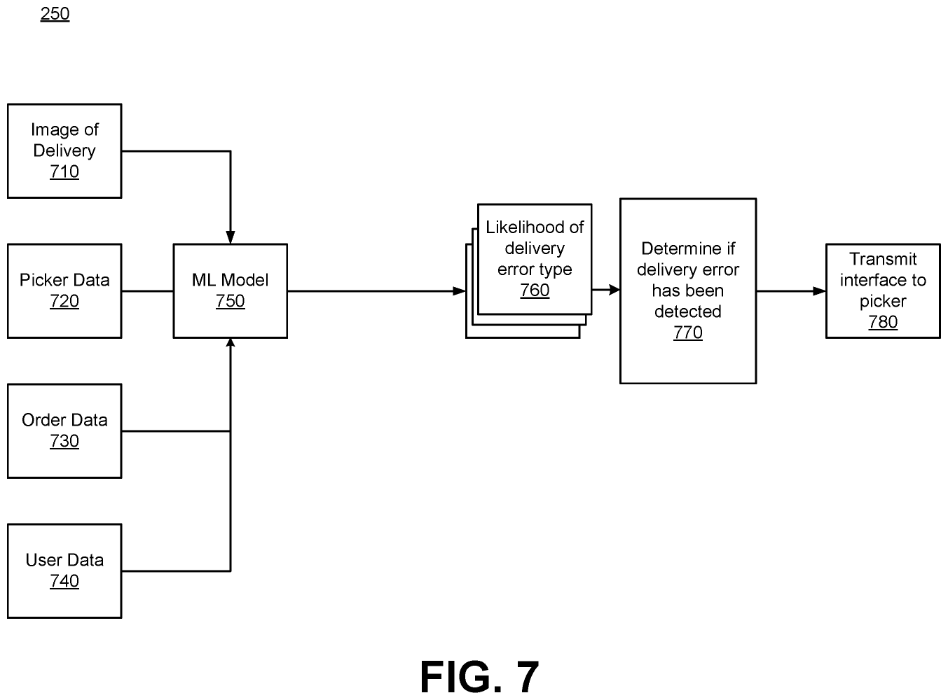

FIG. 7 illustrates an example error prediction module 250 for an online system, in accordance with one or more embodiments. An ML Model 750 receives inputs such as an image of a delivery 710 of an order, picker data 720 for a picker who is assigned to fulfill the order, order data 730 for the order being fulfilled, and user data 740 for the user who placed the order. The ML Model 750 predicts a likelihood of a delivery error 760 for each of one or more types of delivery errors. The error prediction module determines 770 if there has been a delivery error, e.g., by comparing the predicted likelihood to a threshold, for each type of delivery error. If a delivery error is detected, a warning is transmitted 780 to the user interface of the picker's device.

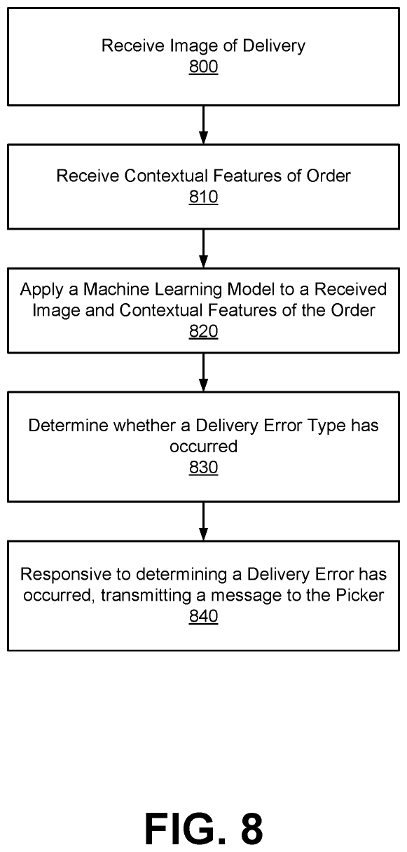

FIG. 8 is a flowchart of a method of an error prediction module, in accordance with one or more embodiments. The error prediction module receives 800 an image of a delivery for a user of an online system. The error prediction module also receives 810 contextual features of an order. The error prediction module applies 820 a machine learning model to the received image and contextual features of the order. In one or more embodiments, the error prediction module determines 830 whether a delivery error type has occurred. Responsive to determining that a delivery error has occurred, the error prediction module transmits 840 a message to the picker. Alternative embodiments may include more, fewer, or different steps from those illustrated in FIG. 8, and the steps may be performed in a different order from that illustrated in FIG. 8. One or more of these steps may be performed by an online system (e.g., online concierge system 140) or locally by the picker client device 110. Additionally, each of these steps may be performed automatically by the online system without human intervention.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, at an online system from a device associated with a delivery agent of the online system, an image of an order delivered at a location of a user associated with the order;
accessing a plurality of features about the order;
applying a machine learning model to the plurality of features and the received image, wherein the model is trained to predict a likelihood that an image includes an error in a delivered order, wherein the machine learning model outputs a likelihood that the received image includes an error in the delivered order;
determining, from the output of the machine learning model, that the order delivered at the location is erroneous; and
responsive to the determining, sending a warning message to the device associated with the delivery agent, wherein the warning message causes the device associated with the delivery agent to display a message about a potential error.

2. The method of claim 1, wherein accessing a plurality of features about the order comprises receiving one or more of:
a batch of orders associated with the delivery agent, wherein the batch of orders comprises a set of orders being simultaneously fulfilled by the delivery agent;
contextual history of the user, wherein the contextual history of the user comprises demographic attributes of the user, order history of the user, and browsing history of the user;
data associated with the delivery agent, wherein the online system receives locational data of the device associated with the delivery agent; or
item data of the order, wherein the item data comprises item identifiers and attributes of the items.

3. The method of claim 1, wherein accessing a plurality of features about the order comprises extracting, from the image of the order, text content depicted in the image, and wherein applying the machine learning model to the plurality of features and the received image comprises applying the machine learning model to the extracted text content.

4. The method of claim 1, wherein applying the machine learning model to the plurality of features and the received image comprises applying a multi-class model to the plurality of features and the received image, wherein the multi-class model generates a probability value for each delivery error type in a multi-label classification.

5. The method of claim 1, wherein sending the warning message to the device associated with the delivery agent comprises transmitting, to the device associated with the delivery agent, a user interface alerting the delivery agent of one or more delivery error types.

6. The method of claim 1, wherein determining, from the output of the machine learning model, that the order delivered at the location is erroneous comprises determining that the order has one or more of:
an erroneous location;
an erroneous number of bags selected for the order;
an erroneous order from a batch of orders associated with the delivery agent; or
an erroneous item in the order.

7. The method of claim 1, further comprising:
generating a training dataset including a set of data instances, wherein a data instance includes inputs comprising the received image and additional features of the order and expected outputs comprising previous orders for which positive indication was received from the user; and
re-training the machine learning model using the training dataset.

8. The method of claim 1, wherein applying the machine learning model to the received image further comprises:
identifying locational attributes of the image by applying text detection recognition methods, to extract attributes of the location of the image;
identifying objects through object detection of the received image; and
passing the identified locational attributes of the image and the identified objects to the machine learning model.

9. A non-transitory computer-readable storage medium storing instructions that when executed by a computer processor cause the computer processor to perform steps comprising:
receiving, at an online system from a device associated with a delivery agent of the online system, an image of an order delivered at a location of a user associated with the order;
accessing a plurality of features about the order;
applying a machine learning model to the plurality of features and the received image, wherein the model is trained to predict a likelihood that an image includes an error in a delivered order, wherein the machine learning model outputs a likelihood that the received image includes an error in the delivered order;
determining, from the output of the machine learning model, that the order delivered at the location is erroneous; and
responsive to the determining, sending a warning message to the device associated with the delivery agent, wherein the warning message causes the device associated with the delivery agent to display a message about a potential error.

10. The non-transitory computer-readable storage medium of claim 9, wherein accessing a plurality of features about the order comprises receiving one or more of:
a batch of orders associated with the delivery agent, wherein the batch of orders comprises a set of orders being simultaneously fulfilled by the delivery agent;
contextual history of the user, wherein the contextual history of the user comprises demographic attributes of the user, order history of the user, and browsing history of the user;
data associated with the delivery agent, wherein the online system receives locational data of the device associated with the delivery agent; or
item data of the order, wherein the item data comprises item identifiers and attributes of the items.

11. The non-transitory computer-readable storage medium of claim 9, wherein accessing a plurality of features about the order comprises extracting, from the image of the order, text content depicted in the image, and wherein applying the machine learning model to the plurality of features and the received image comprises applying the machine learning model to the extracted text content.

12. The non-transitory computer-readable storage medium of claim 9, wherein applying the machine learning model to the plurality of features and the received image comprises applying a multi-class model to the plurality of features and the received image, wherein the multi-class model generates a probability value for each delivery error type in a multi-label classification.

13. The non-transitory computer-readable storage medium of claim 9, wherein sending the warning message to the device associated with the delivery agent comprises transmitting, to the device associated with the delivery agent, a user interface alerting the delivery agent of one or more delivery error types.

14. The non-transitory computer-readable storage medium of claim 9, wherein determining, from the output of the machine learning model, that the order delivered at the location is erroneous comprises determining that the order has one or more of:
an erroneous location;
an erroneous number of bags selected for the order;
an erroneous order from a batch of orders associated with the delivery agent; or
an erroneous item in the order.

15. The non-transitory computer-readable storage medium of claim 9, further comprising:
generating a training dataset including a set of data instances, wherein a data instance includes inputs comprising the received image and additional features of the order and expected outputs comprising previous orders for which positive indication was received from the user; and
re-training the machine learning model using the training dataset.

16. The non-transitory computer-readable storage medium of claim 9, wherein applying the machine learning model to the received image further comprises:
identifying locational attributes of the image by applying text detection recognition methods, to extract attributes of the location of the image;
identifying objects through object detection of the received image; and
passing the identified locational attributes of the image and the identified objects to the machine learning model.

17. A computer system, the computer system comprising:
a computer processor; and
a non-transitory computer-readable storage medium storing instructions that when executed by a computer processor cause the computer processor to perform steps comprising:
receiving, at an online system from a device associated with a delivery agent of the online system, an image of an order delivered at a location of a user associated with the order;
accessing a plurality of features about the order;
applying a machine learning model to the plurality of features and the received image, wherein the model is trained to predict a likelihood that an image includes an error in a delivered order, wherein the machine learning model outputs a likelihood that the received image includes an error in the delivered order;
determining, from the output of the machine learning model, that the order delivered at the location is erroneous; and
responsive to the determining, sending a warning message to the device associated with the delivery agent, wherein the warning message causes the device associated with the delivery agent to display a message about a potential error.

18. The computer system of claim 17, wherein accessing a plurality of features about the order comprises receiving one or more of:
a batch of orders associated with the delivery agent, wherein the batch of orders comprises a set of orders being simultaneously fulfilled by the delivery agent;
contextual history of the user, wherein the contextual history of the user comprises demographic attributes of the user, order history of the user, and browsing history of the user;
data associated with the delivery agent, wherein the online system receives locational data of the device associated with the delivery agent; or
item data of the order, wherein the item data comprises item identifiers and attributes of the items.

19. The computer system of claim 17, wherein determining, from the output of the machine learning model, that the order delivered at the location is erroneous comprises determining that the order has one or more of:
an erroneous location;
an erroneous number of bags selected for the order;
an erroneous order from a batch of orders associated with the delivery agent; or
an erroneous item in the order.

20. The computer system of claim 17, further comprising:
generating a training dataset including a set of data instances, wherein a data instance includes inputs comprising the received image and additional features of the order and expected outputs comprising previous orders for which positive indication was received from the user; and
re-training the machine learning model using the training dataset.
